(19) United States
(12) Patent Application Publication
(10) Pub. No.: US 2025/0110591 A1
(43) Pub. Date: Apr. 3, 2025

(54) False-Input Suppression at Touch-Sensitive Displays

(71) Applicant: Google LLC, Mountain View, CA (US)

(72) Inventors: Leonardo Blanger, Taipei City (TW); Chiayun Kuan, San Jose, CA (US); Stephen Mathew Pfetsch, Sunnyvale, CA (US)

(73) Assignee: Google LLC, Mountain View, CA (US)

(21) Appl. No.: 18/397,466

(22) Filed: Dec. 27, 2023

Related U.S. Application Data
(60) Provisional application No. 63/587,705, filed on Oct. 3, 2023.

(51) Int. Cl. G06F 3/041; G06F 3/044; G06F 18/2415

(52) U.S. Cl. CPC G06F 3/0418; G06F 3/044; G06F 18/2415

(57) ABSTRACT

This document describes systems and techniques for false-input suppression at touch-sensitive displays. In aspects, an electronic device with a touch-sensitive display generates a touch frame having a heatmap matrix based on touch input received at the touch-sensitive display. The electronic device further obtains contextual data to determine if the contextual data satisfies contextual conditions. If the contextual conditions are satisfied, a machine-learned model analyzes the touch frame to generate a confidence score for a likelihood that one or more hotspots within the heatmap matrix are indicative of touch inputs from machine-learned entities. Based on the confidence score being above a threshold, the electronic device suppresses touch inputs to prevent user interface interactions.

### CROSS-REFERENCE TO RELATED APPLICATION(S)

This application claims priority to U.S. Provisional Patent Application Ser. No. 63/587,705 filed on Oct. 3, 2023, the disclosure of which is incorporated by reference herein in its entirety.

### BACKGROUND

Electronic devices continue to make significant contributions to modern society, such as in the realms of safety, transportation, communication, and the like, propelling their integration into the daily lives of users. To support integration and enhance user experience, many electronic devices are designed to provide users convenient manners by which to access, control, or navigate their devices. For instance, some electronic devices permit users to speak voice commands to call family, perform in-the-air gestures to skip songs, offer biometric identifiers to unlock devices, squeeze a housing of a device to activate an intelligent virtual assistant, and employ many other methods of interaction to operate these devices. These methods of interaction expedite user-input and device-output techniques, enhancing user experience by enabling users to quickly and conveniently operate their device.

One popular method of interaction includes enabling users to provide touch input at touch-sensitive displays. Through this method of interaction, users can interact with graphical user interfaces and elements thereon. However, in some contexts, touch-sensitive displays can receive accidental input from users or other objects.

### SUMMARY

This document describes systems and techniques directed at false-input suppression at touch-sensitive displays. In aspects, an electronic device with a touch-sensitive display generates a touch frame based on touch input received at the touch-sensitive display. In implementations, the touch frame includes at least one of a heatmap matrix and touch input data (e.g., touch input coordinates, touch input timing). A machine-learned model then analyzes the touch frame to generate a confidence score for a likelihood that one or more hotspots within the heatmap matrix are indicative of touch inputs from machine-learned entities. Based on the confidence score being above a threshold, the electronic device suppresses touch inputs to prevent user interface interactions.

In some aspects, computer-readable media is disclosed for false-input suppression at touch-sensitive displays. In further aspects, an electronic device is disclosed. The electronic device includes a touch-sensitive display, one or more processors, and memory. The memory stores instructions that, when executed by the one or more processors, cause the one or more processors to implement a touch detection manager to suppress false inputs at the touch-sensitive display by performing the method above.

The details of one or more implementations are set forth in the accompanying drawings and the following description. Other features and advantages will be apparent from the description, the drawings, and the claims. This Summary is provided to introduce subject matter that is further described in the Detailed Description. Accordingly, a reader should not consider the Summary to describe essential features or to limit the scope of the claimed subject matter.

### BRIEF DESCRIPTION OF THE DRAWINGS

The details of one or more aspects of systems and techniques for false-input suppression at touch-sensitive displays are described in this document with reference to the following drawings. The same numbers are used throughout the drawings to reference like features and components:

FIG. 1 illustrates an example implementation of an electronic device receiving a false input at a touch-sensitive display;

FIG. 2 illustrates an example implementation of an electronic device that is configured to detect false inputs at a touch-sensitive display in accordance with one or more implementations;

FIG. 3 illustrates example electronic devices that are capable of implementing false-input suppression at touch-sensitive displays in accordance with one or more implementations;

FIG. 4 illustrates an example touch-sensitive display in accordance with one or more implementations;

FIG. 5 illustrates an example implementation of an example electronic device having an example touch-sensitive display manufactured as a display panel stack in accordance with one or more implementations;

FIG. 6 illustrates an example implementation of an example electronic device having an example touch-input sensor configured to detect touch input in accordance with one or more implementations;

FIG. 7 illustrates an example algorithmic logic tree of a touch detection manager to suppress false inputs at touch-sensitive displays in accordance with one or more implementations;

FIG. 8 illustrates the touch detection manager configured to suppress false inputs at touch-sensitive displays in accordance with one or more implementations; and

FIG. 9 illustrates an example method of the touch detection manager in accordance with one or more implementations.

### DETAILED DESCRIPTION

### Overview

Touch-sensitive displays permit users to interact with electronic devices via a touch-input and visual-output interface. Such touch-sensitive display technology includes, but is not limited to, resistive touch, capacitive touch, surface acoustic wave (SAW) touch, infrared (IR) touch, and optical touch. Users generally appreciate services made available by touch-sensitive displays.

However, in some circumstances, touch-sensitive displays may receive false input, including unintended or incorrect touch input that is registered by an electronic device. In one example, an electronic device stored in a pocket or purse may receive false input caused by other objects coming in contact with a touch-sensitive display. In another example, a user may accidentally provide false input during a voice call.

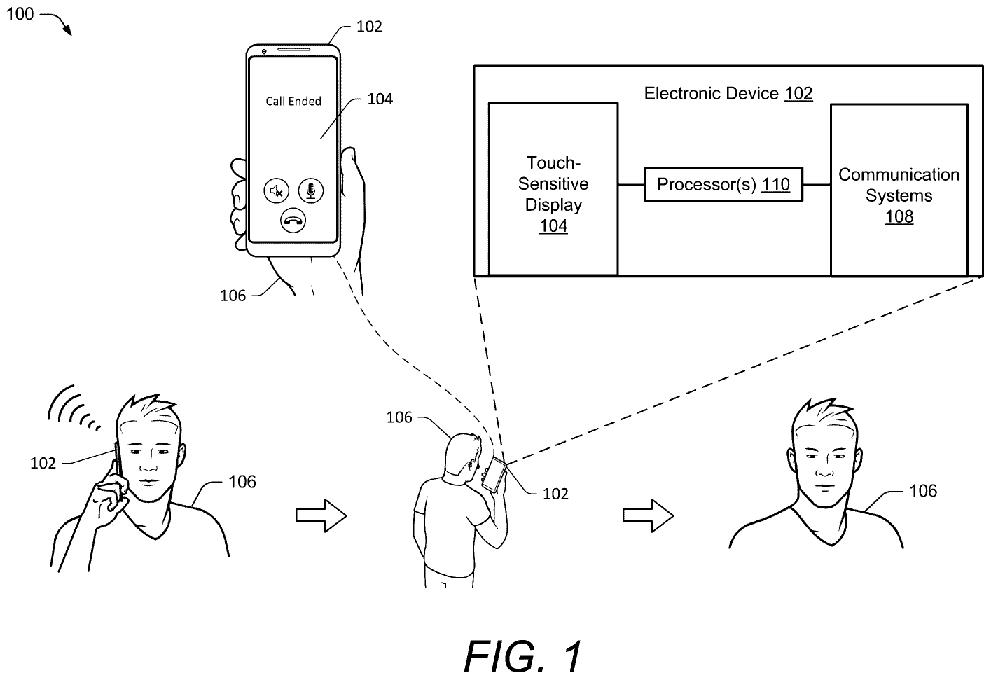

Consider FIG. 1, which illustrates an example implementation 100 of an electronic device 102 receiving false input at a touch-sensitive display 104. As illustrated, a user 106 is engaged in a voice call via communication systems 108 of the electronic device 102. During the voice call, while the touch-sensitive display 104 is positioned adjacent to an ear or a cheek of the user 106, one or more processors 110 may register the ear or the cheek as a touch input at the touch-sensitive display 104. Such false input, unintentionally provided by the user 106, may cause the electronic device 102 to, for example, end a call, mute the user 106, alter a volume, or perform additional, undesirable actions. Users may be frustrated by one or more of these actions caused by the false input.

In some implementations, during voice calls, electronic devices may use a proximity sensing device (e.g., a radar sensor, an optical sensor, an ultrasonic sensor) to identify when the electronic device 102 is adjacent to the ear or the cheek of the user 106. In this way, electronic devices can use a proximity estimation to determine when to turn off the touch-sensitive display 104 (e.g., the screen, a sensing grid). However, in many cases, the proximity sensing device can fail or provide unreliable data, causing the touch-sensitive display 104 to remain on during the voice call. In an example, the proximity sensing device may provide an inaccurate proximity estimation when the touch-sensitive display 104 receives incident high-luminous light (e.g., sunlight). In additional cases, a positioning of the proximity sensing device within the electronic device 102 can influence the proximity estimations in ways that are dependent upon behaviors of the user 106. For instance, if the proximity sensing device is disposed within the electronic device 102 offset to one side, the proximity sensing may be different if the user 106 holds the electronic device 102 with a left hand or a right hand.

To this end, this document describes systems and techniques for false-input suppression at touch-sensitive displays. In aspects, an electronic device with a touch-sensitive display generates a touch frame based on touch input received at the touch-sensitive display. In implementations, the touch frame includes at least one of a heatmap matrix and touch input data (e.g., touch input coordinates, touch input timing). A machine-learned model then analyzes the touch frame to generate a confidence score for a likelihood that one or more hotspots within the heatmap matrix are indicative of touch inputs from machine-learned entities. Based on the confidence score being above a threshold, the electronic device suppresses touch inputs to prevent user interface interactions.

### Operating Environment

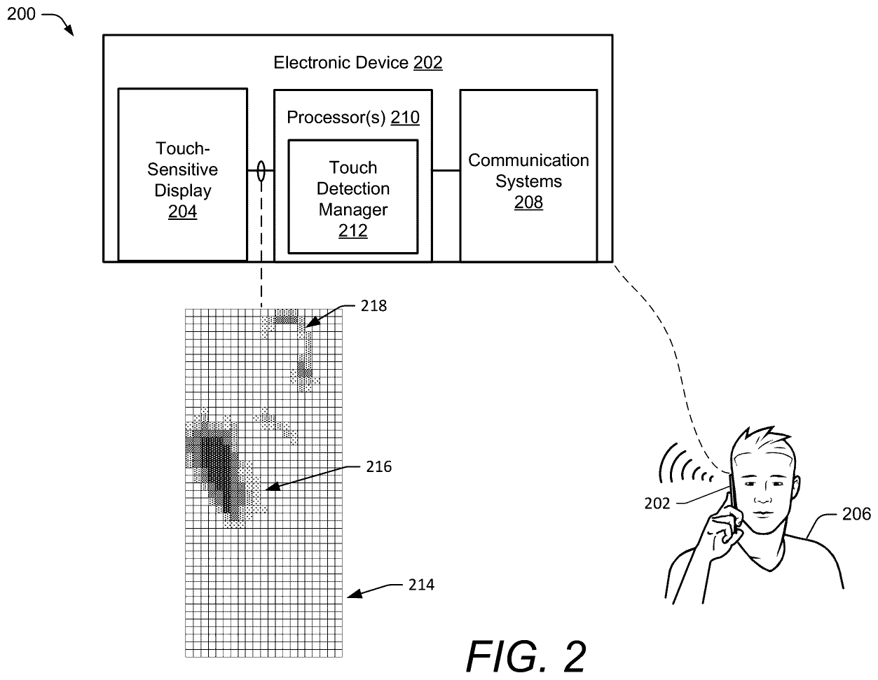

FIG. 2 illustrates an example implementation 200 of an electronic device 202 that is configured to detect false inputs at a touch-sensitive display 204 in accordance with one or more implementations. As illustrated, the electronic device 202 (e.g., a smartphone) includes the touch-sensitive display 204, communication systems 208, and one or more processors 210. The one or more processors 210 are configured to execute a touch detection manager 212.

In implementations, during a voice call, for example, when a user 206 positions the touch-sensitive display 204 adjacent to his cheek and/or ear, the touch-sensitive display 204 receives input and generates a touch frame. In implementations, a touch frame includes a discrete bundle of touch information reported by the touch-sensitive display 204 at a given scanning interval. The touch information includes a heatmap matrix (e.g., heatmap matrix 214) indicative of an intensity, size, and/or location of a touch measured over a sensor grid. The touch information further includes a list of touch coordinates identified by the touch-sensitive display 204. The touch coordinates may be used by the one or more processors 210 to determine UI interactions.

In the example implementation 200 illustrated in FIG. 2, the touch detection manager 212, executing on the one or more processors 210, receives the touch information, including the heatmap matrix 214 from the touch-sensitive display 204. The touch detection manager 212 then analyzes the touch information (e.g., hotspot analysis) to determine if hotspot regions include machine-learned entities, such as a hotspot region indicative of at least portions of an ear and/or a cheek. For example, illustrated in FIG. 2, the heatmap matrix 214 includes two hotspot regions indicative of a cheek 216 and an ear 218 of the user 206. The touch detection manager 212 can analyze the heatmap to identify (e.g., classify) these hotspot regions as machine-learned entities and determine the touch input to be false input. In this way, the touch detection manager 212 can suppress one or more touch inputs (e.g., touch coordinates) and, thereby, prevent UI interactions. As a result, the user 206 can continue to engage in the voice call.

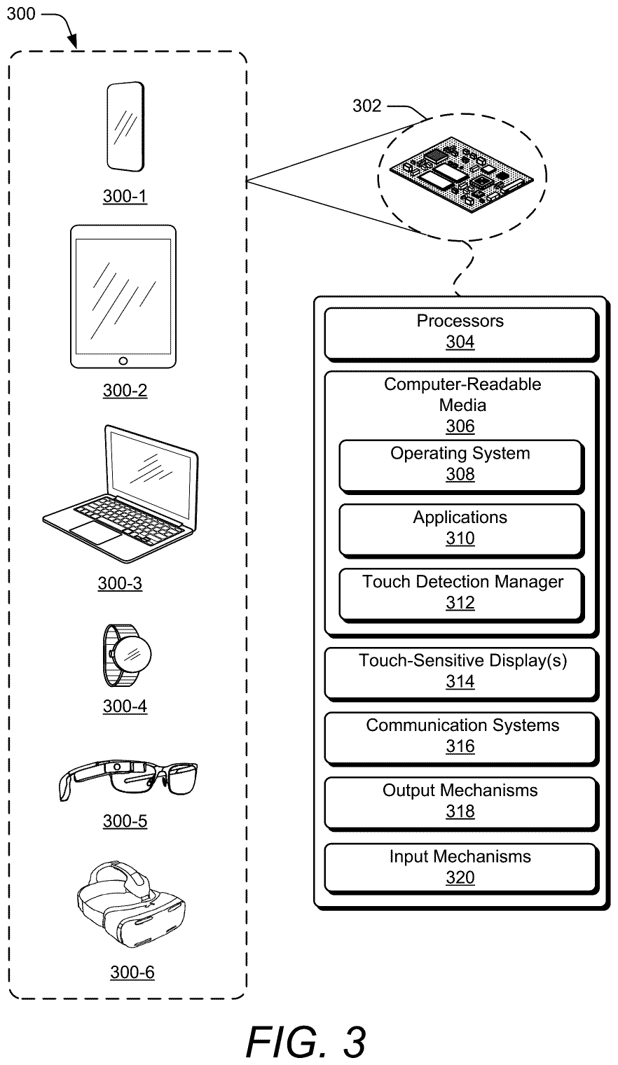

In more detail, FIG. 3 illustrates example electronic devices 300 (e.g., electronic device 202) that are capable of implementing false-input suppression at touch-sensitive displays in accordance with one or more implementations. Examples of an electronic devices 300 include a smartphone 300-1, a tablet 300-2, a laptop 300-3, a smartwatch 300-4, smart glasses 300-5, and virtual-reality (VR) goggles 300-6. Although not shown, the electronic device 300 may also be implemented as any of a mobile station (e.g., fixed- or mobile-STA), a mobile communication device, a client device, a home automation and control system, an entertainment system, a gaming console, a personal media device, a health monitoring device, a drone, a camera, an Internet home appliance capable of wireless Internet access and browsing, an IoT device, security systems, and the like. Note that the electronic devices 300 can be wearable, non-wearable but mobile, or relatively immobile (e.g., desktops, appliances). Note also that the electronic devices 300 can be used with, or embedded within, electronic devices or peripherals, such as in automobiles (e.g., steering wheels) or as an attachment to a laptop computer. The electronic devices 300 may include components or interfaces omitted from FIG. 3 for the sake of clarity or visual brevity.

For example, although not shown, the electronic devices 300 can also include a system bus, interconnect, crossbar, or data transfer system that couples the various components within the device. A system bus or interconnect can include any one or combination of different bus structures, such as a memory bus or memory controller, a peripheral bus, a universal serial bus, and/or a processor or local bus that utilizes any of a variety of bus architectures.

As illustrated, the electronic devices 300 can include a printed circuit board assembly 302 (PCBA 302) on which components and interconnects of the electronic devices 300 are embodied. Alternatively or additionally, components of the electronic devices 300 can be embodied on other substrates, such as flexible circuit material or other insulative material, and, optionally, can be operatively coupled to the PCBA 302. The electronic devices 300 can further include a housing that defines at least one internal cavity. The housing includes an exterior surface and an opposing interior surface. In some implementations, the exterior surface may include at least one portion in contact with a physical medium (e.g., hair, skin, tissue, clothing) associated with a user. For example, the smartwatch 300-4 can include an exterior surface in contact with a wrist of a user. In aspects, the housing may be any of a variety of plastics, metals, acrylics, or glasses. In an implementation, the exterior surface of the housing includes one or more channels (e.g., holes, ports). Although not illustrated, various other electronic components or devices can be housed in the internal cavity of the device. Generally, electrical components and electromechanical components of the electronic devices 300 are assembled onto a printed circuit board (PCB) to form the PCBA 302. Various components of the PCBA 302 (e.g., processors and memories) are then programmed and tested to verify the correct function of the PCBA 302. The PCBA 302 is connected to or assembled with other parts of the electronic devices 300 into a housing.

As illustrated, the electronic devices 300 include one or more processors 304 and computer-readable media 306. The processors 304 may include any suitable single-core or multi-core processor (e.g., an application processor (AP), a digital-signal processor (DSP), a central processing unit (CPU), a graphics processing unit (GPU)). The processors 304 may be configured to execute instructions or commands stored within the computer-readable media 306. The computer-readable media 306 can include an operating system 308, applications 310, and a touch detection manager 312 (e.g., touch detection manager 212). In at least some implementations, the operating system 308 and applications 310 implemented as computer-readable instructions in the computer-readable media 306 can be executed by the processors 304 to provide some or all of the functionalities described herein, such as some or all of the functions of the touch detection manager 312. The computer-readable media 306 may be stored within one or more storage devices (e.g., non-transitory storage devices) such as a random access memory (RAM, dynamic RAM (DRAM), non-volatile RAM (NVRAM), or static RAM (SRAM)), read-only memory (ROM), or flash memory, a hard drive, a solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other but still cooperate and/or interact with each other.

The electronic devices 300 may also include and/or be operatively coupled to one or more touch-sensitive displays 314 (e.g., touch-sensitive display 204). Although an organic light-emitting diode (OLED) display is described herein, it is provided as an example only. The electronic devices 300 may include or utilize any of a variety of displays, including an active-matrix OLED (AMOLED) display, an electroluminescent display (ELD), a microLED display, a liquid crystal display (LCD), a thin film transistor (TFT) LCD, an in-place switching (IPS) LCD, and so forth. It will also be appreciated by one skilled in the art that any display, including any of the aforementioned displays, utilized in conjunction with one or more touch-input sensors is to be regarded as a touch-sensitive display. Such touch-input sensors can include a 5-wire resistive touch panel, a surface capacitive touch panel, a projected capacitive (P-Cap) touch panel, a SAW touch panel, an IR touch panel, a force touch sensor touch panel, and so on. In implementations, the touch-input sensor may be a transparent substrate.

The electronic devices 300 may further include and/or be operatively coupled to communication systems 316 (e.g., communication systems 208). The communication systems 316 enable communication of device data, such as received data, transmitted data, or other information as described herein, and may provide connectivity to one or more networks and other devices connected therewith. Example communication systems include NFC transceivers, WPAN radios compliant with various IEEE 802.15 (Bluetooth®) standards, WLAN radios compliant with any of various IEEE 802.11 (WiFi®) standards, WWAN (3GPP-compliant) radios for cellular telephony, wireless metropolitan area network (WMAN) radios compliant with various IEEE 802.16 (WiMAX®) standards, IR transceivers compliant with an Infrared Data Association (IrDA) protocol, and wired local area network (LAN) Ethernet transceivers. Device data communicated over the communication systems 316 may be packetized or framed depending on a communication protocol or standard by which the electronic devices 300 are communicating. The communication systems 316 may include wired interfaces, such as Ethernet or fiber-optic interfaces for communication over a local network, a private network, an intranet, or the Internet. Alternatively, or additionally, the communication systems 316 may include wireless interfaces that facilitate communication over wireless networks, such as wireless LANs, cellular networks, or WPANs.

The electronic devices 300 may also include, and/or be operatively coupled with, one or more output mechanisms 318. The output mechanisms 318 may include light-emitting diodes, audio output components (e.g., speakers), haptic feedback actuators, and so on. The electronic devices 300 can further include, and/or be operatively coupled with, one or more input mechanisms 320. The input mechanisms 320 can include any of a variety of sensors, such as an audio sensor (e.g., a microphone), an image-capture device (e.g., a camera, video-camera), proximity sensors (e.g., capacitive sensors), pressure-sensitive actuators, or an ambient light sensor (e.g., photodetector). In implementations, the electronic devices 300 include one or more of a front-facing image sensor(s) and a rear-facing image sensor(s).

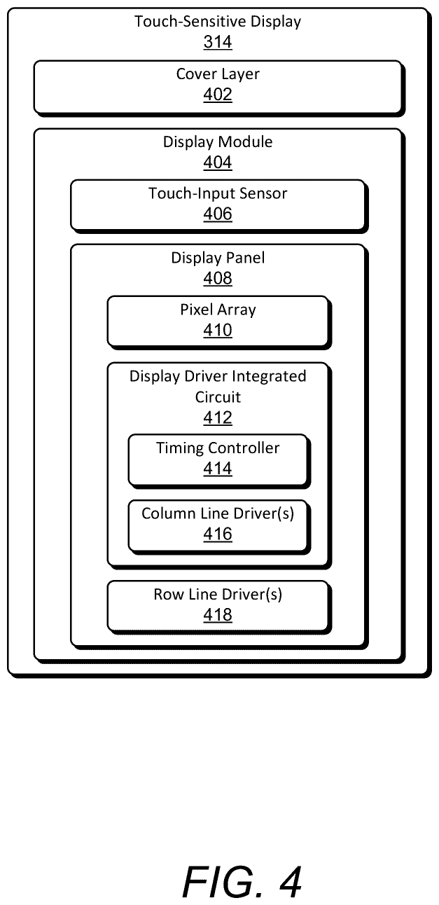

FIG. 4 illustrates an example touch-sensitive display 314 in accordance with one or more implementations. As illustrated, the touch-sensitive display 314 may include a cover layer 402 and a display module 404. The cover layer 402 may be composed of any of a variety of transparent materials including polymers (e.g., plastic, acrylic), glass (e.g., tempered glass), and so forth, forming any three-dimensional shape (e.g., a polyhedron), such as a rectangular prism or cylinder. During manufacturing, a bottom face of the cover layer 402 may be bonded (e.g., glued) to the display module 404 to protect the display module 404 and serve as a barrier to ingress contaminants (e.g., dust, water).

The display module 404 may include a touch-input sensor 406 and a display panel 408. The display panel 408 may include a pixel array 410 of thousands (or millions) of pixel circuits (e.g., low-temperature polycrystalline oxide (LTPO) pixel circuits), forming any two-dimensional grid (e.g., rectangular grid, circular grid, curved grid). Each pixel circuit may include a light-emitting component, such as one or more light-emitting diodes (LEDs), commonly referred to as a pixel.

The display panel 408 may further include a display driver integrated circuit 412 (DDIC 412). The DDIC 412 may include a timing controller 414 and column line driver(s) 416. The column line driver 416 may include, as a non-limiting example, a data-line driver. The display panel 408 may further include row line drivers 418. The row line drivers 418 may include, as non-limiting examples, gate-line drivers, scan-line drivers, and/or emission-control drivers.

The display panel stack may further include, often integrated within the display module 404 but sometimes altogether separate from the display module 404, a collimator, one or more polarizer layers (e.g., polarization filters), one or more adhesive layers (e.g., glue), and a protective layer (e.g., a EMBO layer). The protective layer may include one or more layers, such as a polymer layer (e.g., polyethylene terephthalate (PET) substrate), a metallic layer (e.g., copper layer, stainless steel layer), a foam pad, and an adhesive layer. The protective layer may be on the bottom of the display panel stack (e.g., opposite the cover layer 402), providing protection from, for example, moisture, debris, and/or radiation (e.g., electromagnetic radiation, heat radiation).

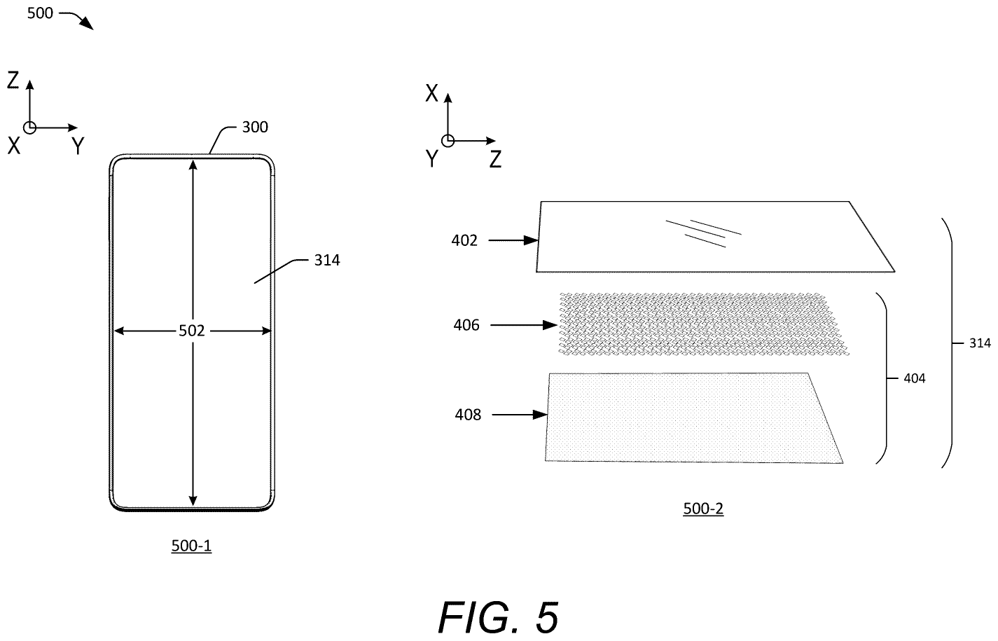

FIG. 5 illustrates an example implementation 500 of the example electronic device 300 (e.g., smartphone 300-1) having the example touch-sensitive display 314 manufactured as a display panel stack in accordance with one or more implementations. As illustrated in a detail view 500-1, at least one layer of the touch-sensitive display 314 (e.g., the cover layer 402) is implemented as a portion of a housing of the electronic device 300. Further, the touch-sensitive display 314 includes an active area 502 that may be visible and/or accessible to touch by users.

A detail view 500-2 illustrates an exploded view of the touch-sensitive display 314. Some components of the touch-sensitive display 314 may be omitted in detail view 500-2 for the sake of clarity. As illustrated, the touch-sensitive display 314 includes the cover layer 402 positioned above the display module 404. The display module 404 includes the touch-input sensor 406 and the display panel 408. In implementations, the display panel 408 is disposed beneath the touch-input sensor 406.

In such a configuration, light emitting from the display panel 408 can pass through the touch-input sensor 406 and the cover layer 402 for viewing by users within the active area 502. Further, users can provide user input on or above the cover layer 402, within the active area 502, for receipt by one or more sensors. For example, users can provide user input on the cover layer 402, within the active area 502, for receipt (e.g., detection) by the touch-input sensor 406.

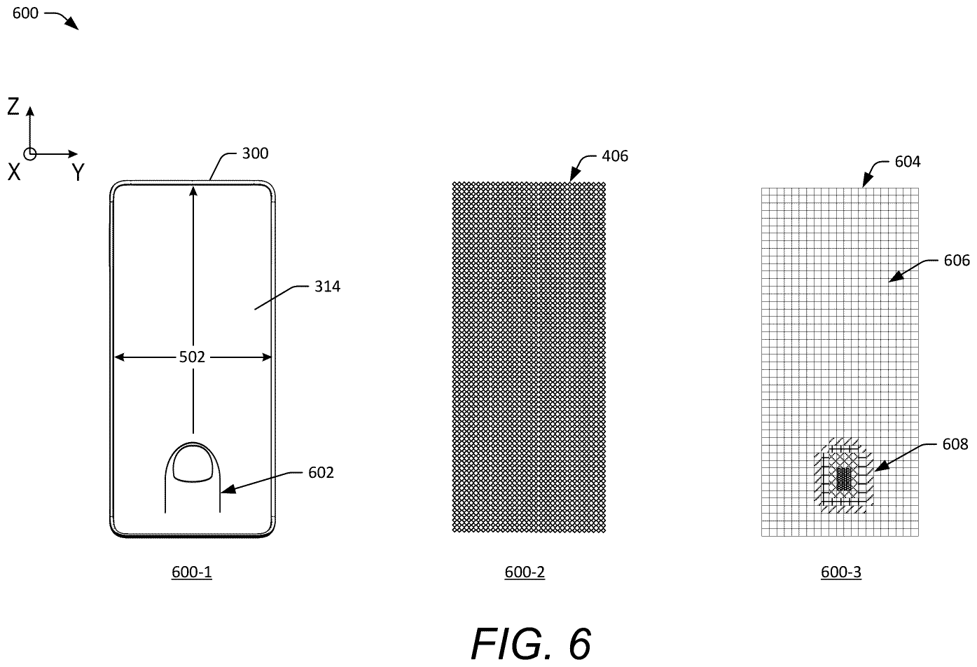

FIG. 6 illustrates an example implementation 600 of the example electronic device 300 having the example touch-input sensor 406 configured to detect touch input in accordance with one or more implementations. As illustrated in a detail view 600-1, a user provides touch input in the form of a thumb 602 at the touch-sensitive display 314. For example, the user presses their thumb 602 on the touch-sensitive display 314 (e.g., the cover layer 402) of the electronic device 300 within the active area 502. In some examples, the user may hover their thumb 602 immediately above the touch-sensitive display 314, such that no portion of the thumb 602 comes in contact with the touch-sensitive display 314. In additional examples, the user may provide different and/or additional user input, including other fingers, a palm, and so on.

Continuing with the example, as illustrated in a detail view 600-2, the touch-input sensor 406 detects the thumb 602 pressed upon the touch-sensitive display 314. The touch-input sensor 406, by way of example only, may detect the thumb 602 using capacitive touch technology. For instance, a controller and/or processor can monitor a conductive matrix (e.g., diamond grid layout, interleaved layout, angled cross pattern layout) by scanning electrical charges or voltages within the matrix to detect variations therein and, thereby, identify a touch input. The touch-input sensor 406 using capacitive touch technology may allow for sub-frame digitization, providing higher resolution, higher precision, and quicker response times than other touch-based technologies.

In aspects, the touch detection manager 312 may be configured to analyze touch inputs received at the touch-input sensor 406 and identify false inputs (e.g., touch-input false positives). Touch input false positives may include any unintentional, or undesired, input received at the touch-input sensor 406 of the electronic device 300. For example, the touch-sensitive display 314 of the electronic device 300 in a pocket of the user's clothing may come in contact with fabric, activating the touch-input sensor 406. In another example, a user may reach into a pocket to grab their electronic device 300 and place it down on a table, touching the touch-sensitive display 314 without the desire to interact with the electronic device 300. In these and other examples, the touch detection manager 312 may be configured to analyze touch inputs received at the touch-input sensor 406 and identify false input based on a number of events or characteristics, including a duration of sustained contact of the touch input with the touch-sensitive display 314, an orientation or acceleration of the electronic device 300, a motion of the touch input across the touch-sensitive display 314, a size of the touch input on the touch-sensitive display 314, and so forth. The touch detection manager 312 may use one or more machine-learned techniques, heuristic algorithms, or any other algorithms to analyze touch information, identify hotspots within a heatmap matrix 604, classify hotspot regions based on a size, shape, and/or intensity, and generate a confidence score for one or more hotspot regions resembling (or being indicative of) machine-learned entities, including an ear and/or a cheek of a user.

In more detail, as illustrated in a detail view 600-3, the touch-input sensor 406 generates a heatmap matrix 604. The heatmap matrix 604 may include a measurement of a capacitive coupling of touch input, indicating an area of sustained contact (“contact area”) between, for example, the thumb 602 and the touch-sensitive display 314. As described herein, sustained contact may be any duration of time sufficient for the electronic device 300, or components therein (e.g., the touch-input sensor 406), to register, process, and/or analyze touch input.

In implementations, one or more regions 606 within the heatmap matrix 604 may indicate a “no-contact area”. Alternatively, one or more regions within the heatmap matrix 604 may indicate a contact area (“contact region 608”) of varying magnitudes, correlating to, as non-limiting examples, a magnitude of pressure applied by the thumb 602 on the touch-sensitive display 314, a degree of coverage of the thumb 602 on the touch-sensitive display 314, and so on.

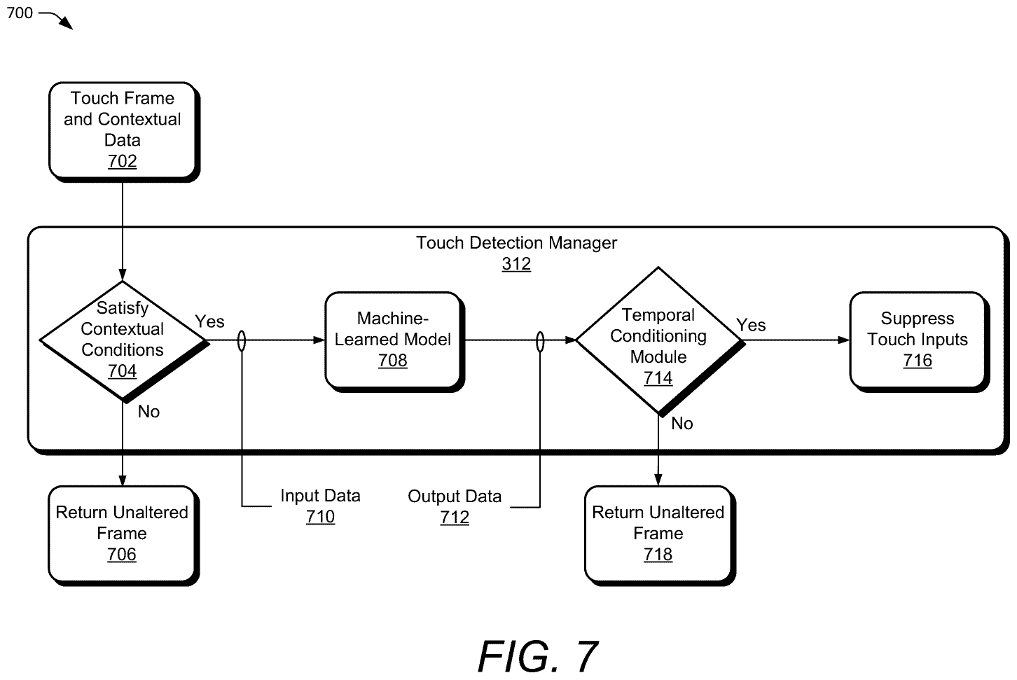

FIG. 7 illustrates an example algorithmic logic tree 700 of the touch detection manager 312 to suppress false inputs at touch-sensitive displays in accordance with one or more implementations. As illustrated, at block 702, the touch detection manager 312 receives a touch frame and contextual data at predetermined intervals. For example, the touch detection manager 312 receives a touch frame and contextual data at a frequency substantially equal to a frame scanning rate of the touch-input sensor 406. In another example, the touch detection manager 312 receives a touch frame and contextual data at a frequency less than the frame scanning rate.

In implementations, the touch frame may include a discrete bundle of touch information obtained by the touch-sensitive display 314 for a given frame scan. The touch information includes a heatmap matrix (e.g., heatmap matrix 604) indicative of an intensity of a touch measured over the touch-input sensor 406. The touch information further includes a list of touch coordinates identified by the touch-sensitive display 314. The touch coordinates may be used by the one or more processors 304 to determine UI interactions.

In further implementations, the contextual data includes information regarding an operating state of the electronic device 300 and/or an environment in which the electronic device 300 resides, as sensed by the one or more input mechanisms 320. For example, an operating state of the electronic device 300 can include an active voice call, an audio playback, a video playback, a voice recording, a low-power mode, an executing gaming application, and the like. The environment in which the electronic device 300 resides can be determined by the processors 304 through analysis of sensed data. For example, the electronic device 300 can determine a placement within a purse using a radar sensor, an image sensor, an ambient light sensor, and so on.

The touch detection manager 312, at block 704, can determine if the contextual data satisfies contextual conditions. For example, a contextual condition can include an operating state indicative of an active voice call. In this way, if the contextual condition is not satisfied, then the touch detection manager 312, at block 706, returns an unaltered frame. For example, if the operating state is not indicative of an ongoing voice call, then the touch detection manager 312 can permit touch inputs to be received at the touch-sensitive display 314 and to be passed to an application or another process. If, however, the contextual condition is satisfied, then the touch detection manager 312, at block 708, transmits input data 710, including the touch frame and/or the contextual data, to a machine-learned model.

In implementations, the machine-learned model is trained to receive input data 710 of one or more types and, in response, provide output data 712 of one or more types. For example, the input data 710 can include one or more features that are associated with an instance or an example. The one or more features associated with the instance or example can then be organized into a feature vector. In some implementations, the output data 712 can include one or more predictions. Predictions can also be referred to as inferences. Thus, given features associated with a particular instance, the machine-learned model can output a prediction for such instance based on the features.

The machine-learned model can be or include one or more of various different types of machine-learned models. In particular, in some implementations, the machine-learned model can perform classification, regression, and/or other tasks.

In some implementations, the machine-learned model can perform various types of classification based on the input data 710. For example, the machine-learned model can perform binary classification or multiclass classification. In binary classification, the output data 712 can include a classification of the input data 710 into one of two different classes. In multiclass classification, the output data 712 can include a classification of the input data 710 into one (or more) of more than two classes. The classifications can be single-label or multi-label.

In some implementations, the machine-learned model can perform discrete categorical classification in which the input data 710 is simply classified into one or more classes or categories. In additional implementations, the machine-learned model can perform classification in which the machine-learned model provides, for each of one or more classes, a numerical value descriptive of a degree to which it is believed that the input data 710 should be classified into the corresponding class. In some instances, the numerical values provided by the machine-learned model can be referred to as “confidence scores” that are indicative of a respective confidence associated with classification of the input into the respective class. In some implementations, the confidence scores can be compared to one or more thresholds to render a discrete categorical prediction. In some implementations, only a certain number of classes (e.g., one) with the relatively largest confidence scores can be selected to render a discrete categorical prediction.

In further implementations, the machine-learned model can provide a probabilistic classification. For example, the machine-learned model can be able to predict, given a sample input, a probability distribution over a set of classes. Thus, rather than outputting only the most likely class to which the sample input should belong, the machine-learned model can output, for each class, a probability that the sample input belongs to such class. In some implementations, the probability distribution over all possible classes can sum to one. In some implementations, a softmax function or layer can be used to squash a set of real values respectively associated with the possible classes to a set of real values in the range (0, 1) that sum to one.

In some implementations, the probabilities provided by the probability distribution can be compared to one or more thresholds to render a discrete categorical prediction. In some implementations, only a certain number of classes (e.g., one) with the relatively largest predicted probability can be selected to render a discrete categorical prediction.

In some implementations in which the machine-learned model performs classification, the machine-learned model can be trained using supervised learning techniques. For example, the machine-learned model can be trained on a training dataset that includes training examples labeled as belonging (or not belonging) to one or more classes. Further details regarding supervised training techniques are provided below.

In some implementations, the machine-learned model can be or include one or more classifier models such as, for example, linear classification models, quadratic classification models, and so on.

In some implementations, the machine-learned model can be or include one or more convolutional neural networks. In some instances, a convolutional neural network can include one or more convolutional layers that perform convolutions over input data 710 using learned filters. Filters can also be referred to as kernels. Convolutional neural networks can be especially useful for vision problems such as when the input data 710 includes imagery such as a heatmap matrix, still images, or video.

The machine-learned model can be trained or otherwise configured to receive the input data 710 and, in response, provide the output data 712. The input data 710 can include different types, forms, or variations of input data 710. As an example, in various implementations, the input data 710 can include a heatmap matrix (e.g., heatmap matrix 604).

In some implementations, the machine-learned model can receive and use the input data 710 in its raw form. In some implementations, the raw input data 710 can be preprocessed. Thus, in addition or alternatively to the raw input data 710, the machine-learned model can receive and use the preprocessed input data 710.

In some implementations, preprocessing the input data 710 can include extracting one or more additional features from the raw input data 710. For example, feature extraction techniques can be applied to the input data 710 to generate one or more new, additional features. Example feature extraction techniques include edge detection, corner detection, blob detection, ridge detection, scale-invariant feature transform, motion detection, optical flow, Hough transform, and so on.

In some implementations, the extracted features can include statistics calculated from the input data 710 or certain portions or dimensions of the input data 710. Example statistics include the mode, mean, maximum, minimum, or other metrics of the input data 710 or portions thereof.

As another example preprocessing technique, some or all of the input data 710 can be scaled, standardized, normalized, generalized, and/or regularized. Example regularization techniques include ridge regression, least absolute shrinkage and selection operator (LASSO), elastic net, least-angle regression, cross-validation, L1 regularization, L2 regularization, and so on. As one example, some or all of the input data 710 can be normalized by subtracting the mean across a given dimension's feature values from each individual feature value and then dividing by the standard deviation or other metric.

As another example preprocessing technique, some of all or the input data 710 can be quantized or discretized. As yet another example, qualitative features or variables included in the input data 710 can be converted to quantitative features or variables. For example, one hot encoding can be performed.

In response to receipt of the input data 710, the machine-learned model can provide the output data 712. The output data 712 can include different types, forms, or variations of output data 712. As an example, in various implementations, the output data 712 can include a confidence score. For example, the confidence score can represent how strongly the machine-learned model (e.g., a classifier) considers a current touch frame to include touch input from, for example, an ear or a cheek.

As discussed above, in some implementations, the output data 712 can include various types of classification data (e.g., binary classification, multiclass classification, single label, multi-label, discrete classification, regressive classification, probabilistic classification, etc.) or can include various types of regressive data (e.g., linear regression, polynomial regression, nonlinear regression, simple regression, multiple regression, etc.).

In some implementations, the output data 712 can influence downstream processes or decision-making. As one example, in some implementations, the output data 712 can be interpreted and/or acted upon by a rules-based regulator. In additional implementations, the output data 712 can be utilized by another component (e.g., processor) or algorithm, in conjunction with data from a proximity sensing device, to determine whether to deactivate the touch-sensitive display 314.

In aspects, the present disclosure provides systems and methods that include or otherwise leverage one or more machine-learned models to determine a confidence score of one or more hotspots within a heatmap matrix being indicative of machine-learned entities, such as an ear, a cheek, hair, and so on. Any of the different types or forms of input data 710 described above can be combined with any of the different types or forms of machine-learned models described above to provide any of the different types or forms of output data 712 described above.

In some implementations, the machine-learned model can be stored at and/or implemented locally by an embedded device or a user computing device such as a mobile device. Output data 712 obtained through local implementation of the machine-learned model at the embedded device or the user computing device can be used to improve performance of the embedded device or the user computing device (e.g., an application implemented by the embedded device or the user computing device).

In other implementations, the machine-learned model can be stored at and/or implemented by a server computing device. In some instances, output data 712 obtained through implementation of the machine-learned model at the server computing device can be used to improve other server tasks or can be used by other non-user devices to improve services performed by or for such other non-user devices. For example, the output data 712 can improve other downstream processes performed by the server computing device for a user computing device or embedded computing device. In other instances, output data 712 obtained through implementation of the machine-learned model at the server computing device can be sent to and used by a user computing device, an embedded computing device, or some other client device. For example, the server computing device can be said to perform machine learning as a service.

In yet other implementations, different respective portions of the machine-learned model can be stored at and/or implemented by some combination of an electronic device (e.g., electronic device 300), an embedded computing device, and/or a server computing device.

In some implementations, multiple instances of the machine-learned model can be parallelized to provide increased processing throughput. For example, the multiple instances of the machine-learned model can be parallelized on a single processing device or computing device or parallelized across multiple processing devices or electronic devices.

Each computing device that implements the machine-learned model or other aspects of the present disclosure can include a number of hardware components that enable performance of the techniques described herein. For example, each computing device can include one or more memory devices that store some or all of the machine-learned model. For example, the machine-learned model can be a structured numerical representation that is stored in memory. The one or more memory devices can also include instructions for implementing the machine-learned model or performing other operations. Example memory devices include RAM, ROM, EEPROM, EPROM, flash memory devices, magnetic disks, etc., and combinations thereof.

Each computing device can also include one or more processing devices that implement some or all of the machine-learned model and/or perform other related operations. Example processing devices include one or more of a CPU; a visual processing unit (VPU); a GPU; a tensor processing unit (TPU); a neural processing unit (NPU); a neural processing engine; a core of a CPU, VPU, GPU, TPU, NPU, or other processing device; an application-specific integrated circuit (ASIC); a field-programmable gate array (FPGA); a co-processor; a controller; or combinations of the processing devices described above. Processing devices can be embedded within other hardware components such as, for example, an image sensor, accelerometer, etc.

Hardware components (e.g., memory devices and/or processing devices) can be spread across multiple physically distributed electronic devices and/or virtually distributed computing systems.

In some implementations, the machine-learned models described herein can be trained at a training computing system and then provided for storage and/or implementation at one or more electronic devices, as described above. For example, a model trainer can be located at the training computing system. The training computing system can be included in or separate from the one or more electronic devices that implement the machine-learned model.

In additional implementations, the model can be trained in an offline fashion or an online fashion. In offline training (also known as batch learning), a model is trained on the entirety of a static set of training data. In online learning, the model is continuously trained (or re-trained) as new training data becomes available (e.g., while the model is used to perform inference).

In still further implementations, the model trainer can perform centralized training of the machine-learned models (e.g., based on a centrally stored dataset). In other implementations, decentralized training techniques such as distributed training, federated learning, or the like can be used to train, update, or personalize the machine-learned models.

The machine-learned models described herein can be trained according to one or more of various different training types or techniques. For example, in some implementations, a machine-learned model can be trained using supervised learning, in which the machine-learned model is trained on a training dataset that includes instances or examples that have labels. The labels can be manually applied by experts, generated through crowd-sourcing, or provided by other techniques (e.g., by physics-based or complex mathematical models). In some implementations, if the user has provided consent, the training examples can be provided by the user computing device. In some implementations, this process can be referred to as personalizing the model.

In some implementations, training data can include examples of the input data 710 that have been assigned labels that correspond to the output data. In additional implementations, the machine-learned model can be trained by optimizing an objective function. For example, in some implementations, the objective function can be or include a loss function that compares (e.g., determines a difference between) output data 712 generated by the model from the training data and labels (e.g., ground-truth labels) associated with the training data. For example, the loss function can evaluate a sum or mean of squared differences between the output data 712 and the labels. As another example, the objective function can be or include a cost function that describes a cost of a certain outcome or output data. Other objective functions can include margin-based techniques such as, for example, triplet loss or maximum-margin training.

In addition, the machine-learning techniques described herein are readily interchangeable and combinable. Although certain example techniques have been described, many others exist and can be used in conjunction with aspects of the present disclosure.

Thus, while the present subject matter has been described in detail with respect to various specific example implementations, each example is provided by way of explanation, not limitation of the disclosure. One of ordinary skill in the art can readily make alterations to, variations of, and equivalents to such implementations. Accordingly, the subject disclosure does not preclude inclusion of such modifications, variations, and/or additions to the present subject matter as would be readily apparent to one of ordinary skill in the art. For instance, features illustrated or described as part of one implementation can be used with another implementation to yield a still further implementation.

In aspects, at block 714, the output data 712 (e.g., a confidence score, a probabilistic value, a binary number) is transmitted to a temporal conditioning module. The temporal conditioning module may include logic configured to consider earlier model predictions from previous touch frames, in order to make a decision to suppress contacts or not. For example, the temporal conditioning module stores information (e.g., confidence scores) from previous touch frames, and if the past ‘n’ touch frames included a confidence score higher than a threshold ‘Tl’, then the temporal conditioning module switches into a suppression mode. On the other hand, if the past ‘n’ touch frames included a confidence score lower than a threshold ‘TO’, then the temporal conditioning module switches out of the suppression mode. If neither condition holds, then the temporal conditioning module maintains the current mode. Thus, instead of the touch detection manager 312 immediately deciding to suppress contacts after the machine-learned model determines a new confidence score, it can wait a few frames, wait a predetermined amount of time, or consider a pair of prediction thresholds. In this way, the temporal conditioning module determines whether to suppress touch inputs, at block 716, or to return an unaltered touch frame, at block 718, a confidence score.

In additional implementations, the touch detection manager 312 can transmit information regarding its determination to suppress or not to suppress touch inputs to other components or algorithms. This information may be useful, for example, in conjunction with proximity sensor data to determine whether to deactivate the touch-sensitive display 314.

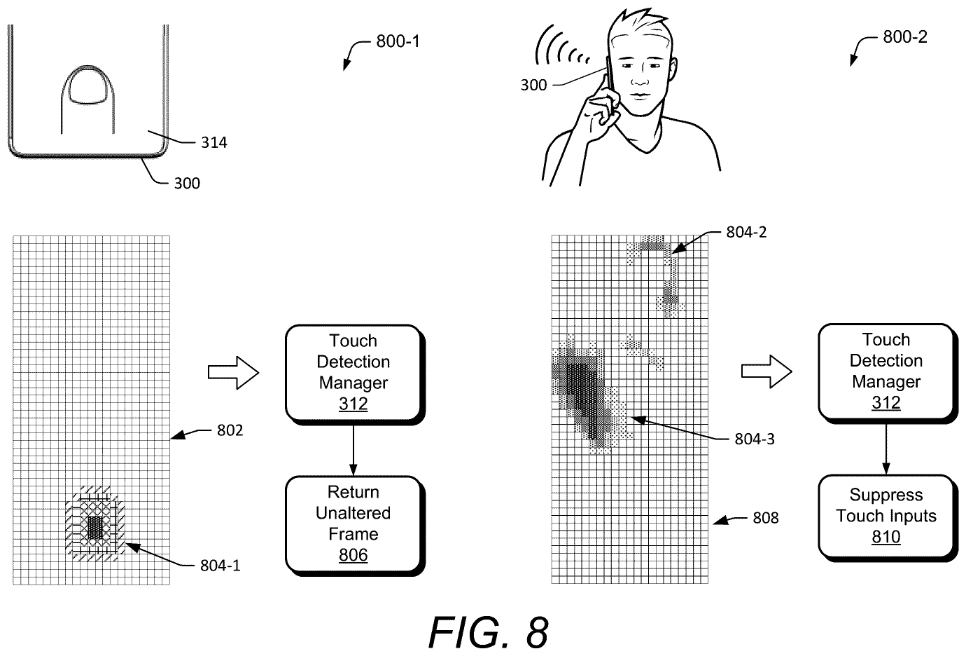

Through such systems and techniques, as illustrated in FIG. 8, the touch detection manager 312 suppresses false inputs at touch-sensitive displays in accordance with one or more implementations. As illustrated in a first detail view 800-1, the touch detection manager 312 is configured to analyze a heatmap matrix 802, determine if one or more hotspots (e.g., hotspot 804-1) are indicative of machine-learned entities (e.g., an ear, a cheek), and make a determination to suppress touch inputs. In implementations, the determination may be further based on confidence scores of one or more previous touch frames. In detail view 800-1, the touch detection manager 312 does not identify machine-learned entities for which touch input suppression may be called for and, therefore, returns an unaltered frame 806.

As illustrated in a second detail view 800-2, the touch detection manager 312 is configured to analyze a heatmap matrix 808, determine if one or more hotspots (e.g., hotspot 804-2, hotspot 804-3) are indicative of machine-learned entities (e.g., an ear, a cheek), and make a determination to suppress touch inputs. In implementations, the determination may be further based on confidence scores of one or more previous touch frames. In detail view 800-2, the touch detection manager 312 identifies machine-learned entities for which touch input suppression may be called for and, therefore, suppresses touch inputs 810. For example, suppression of touch inputs 810 may include instructing the one or more processors 304 to perform at least one of disregarding touch inputs, preventing UI interactions, restarting a proximity sensor, deactivating the touch-sensitive display 314, or so on.

### Example Method

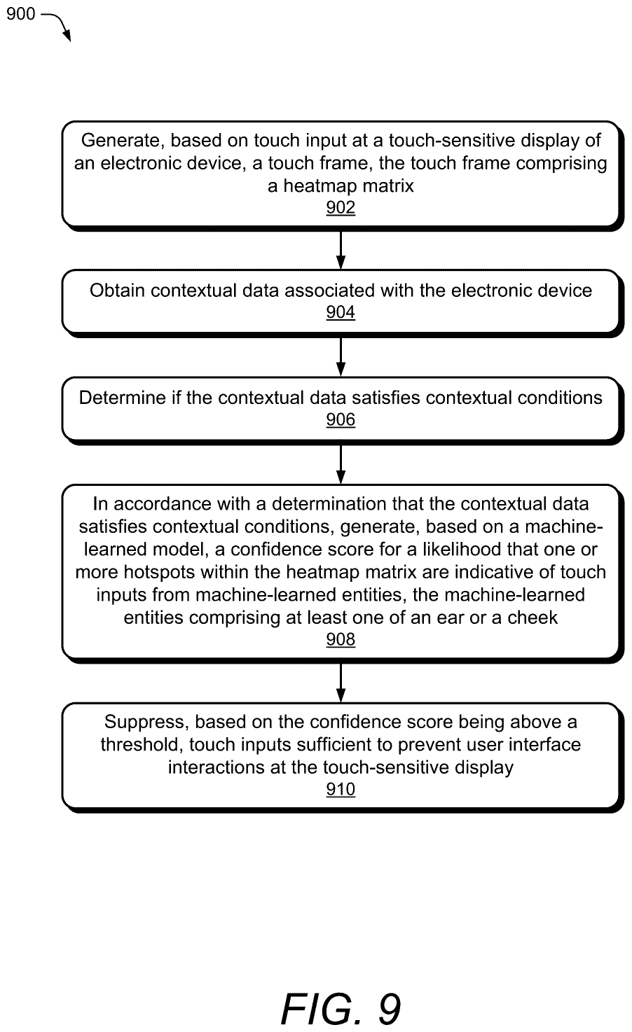

An example method 900 is described with reference to FIG. 9 to illustrate an example method of a touch detection manager (e.g., touch detection manager 312) to suppress false inputs at touch-sensitive displays (e.g., touch-sensitive display 314). This method is shown as sets of blocks that specify operations performed but are not necessarily limited to the order or combinations shown for performing the operations by the respective blocks. For example, any number of the described method blocks can be skipped or combined in any order to implement a method or an alternate method. In portions of the following discussion, reference may be made to entities or environments detailed in FIGS. 2-8 for example only. The techniques are not limited to performance by one entity or multiple entities operating on one device.

Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

As illustrated in FIG. 9, at block 902, an electronic device generates, based on touch input at a touch-sensitive display, a touch frame. The touch frame may include a heatmap matrix and touch input data.

At block 904, the touch detection manager obtains contextual data indicative of an operating state of the electronic device. In implementations, the operating state of the electronic device can include an active voice call, an audio playback, a video playback, a voice recording, a low-power mode, an executing gaming application, and the like. The contextual data may be further indicative of an environment in which the electronic device resides, as sensed by one or more input mechanisms. For example, the contextual data may be indicative of the electronic device residing within a purse, a pocket, on a table, or so on.

At block 906, the touch detection manager determines if the contextual data satisfies contextual conditions, such as if the electronic device is currently facilitating a voice call, audio/video playback, an audio recording, biometric measurements, or so on.

At block 908, in accordance with a determination that the contextual data satisfies the contextual conditions, the touch detection manager generates, based on a machine-learned model, a confidence score for a likelihood that one or more hotspots within the heatmap matrix are indicative of touch inputs from machine-learned entities. In implementations, the machine-learned entities include at least one of an ear, a cheek, hair, clothing, or so on.

At block 910, the touch detection manager suppresses, based on the confidence score being above a threshold, touch inputs sufficient to prevent user interface interactions. Optionally, the suppression of touch inputs is further based on the touch detection manager considering earlier model predictions from previous touch frames. For example, the touch detection manager includes a temporal conditioning module that stores information (e.g., confidence scores) from previous touch frames. If the past ‘n’ touch frames included a confidence score higher than a threshold ‘Tl’, then the temporal conditioning module switches into a suppression mode. On the other hand, if the past ‘n’ touch frames included a confidence score lower than a threshold ‘TO’, then the temporal conditioning module switches out of the suppression mode. If neither condition holds, then the temporal conditioning module maintains the current mode. Thus, instead of the touch detection manager immediately deciding to suppress contacts after the machine-learned model determines a new confidence score, it can wait a few frames, wait a predetermined amount of time, or consider a pair of prediction thresholds. In this way, the temporal conditioning module determines whether to suppress touch inputs or to return an unaltered touch frame.

### CONCLUSION

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations for false-input suppression at touch-sensitive displays have been described in language specific to certain features and/or methods, the subject of the appended Claims is not necessarily limited to the specific features or methods described. Rather, the specific features and methods are disclosed as example implementations for false-input suppression at touch-sensitive displays.

1. A method comprising:
generating, based on a first touch input at a touch-sensitive display of an electronic device, a first touch frame, the first touch frame comprising a first heatmap matrix;
obtaining contextual data associated with the electronic device;
determining if the contextual data satisfies contextual conditions;
in accordance with a determination that the contextual data satisfies contextual conditions, generating, based on a machine-learned model, a first confidence score for a first likelihood that one or more first hotspots within the first heatmap matrix are indicative of touch inputs from machine-learned entities, the machine-learned entities comprising at least one of portions of an ear or portions of a cheek;
generating, based on a second touch input at the touch-sensitive display of the electronic device, a second touch frame, the second touch frame comprising a second heatmap matrix;
generating, based on the machine-learned model, a second confidence score for a second likelihood that one or more second hotspots within the second heatmap matrix are indicative of touch inputs from machine-learned entities, the machine-learned entities comprising at least one of a portion of an ear, a finger, a thumb, a palm, hair, or a cheek; and
suppressing, based on the second confidence score being above a first threshold and based on the first confidence score, touch inputs sufficient to provide an altered second touch frame, the altered second touch frame not including the one or more second hotspots.

2. (canceled)

3. The method of claim 1, wherein the contextual data associated with the electronic device comprises information indicative of an operating state of the electronic device.

4. The method of claim 3, wherein the operating state is indicative of an active voice call, and wherein the satisfaction of the contextual condition comprises a determination that the electronic device is facilitating the active voice call.

5. The method of claim 3, wherein the operating state is indicative of an active audio/video playback, and wherein the satisfaction of the contextual condition comprises a determination that the electronic device is facilitating the active audio/video playback.

6. The method of claim 1, wherein the contextual data associated with the electronic device further comprises radar data, the radar data indicative of an environment in which the electronic device resides.

7. The method of claim 1, wherein the contextual data associated with the electronic device comprises information indicative of an ambient brightness surrounding the electronic device and an acceleration of the electronic device, and wherein the satisfaction of the contextual condition comprises a determination that the electronic device has been moved and received bright incident light.

8. The method of claim 1, further comprising:
obtaining, based on suppressing touch inputs, proximity sensor data; and
deactivating, based on the proximity sensor data and the second confidence score being above the first threshold, the touch-sensitive display.

9. The method of claim 1, further comprising:
obtaining, prior to generating the second touch frame, proximity sensor data; and
determining, based on the first confidence score being above the first threshold, that the proximity sensor data is unrepresentative of a true proximity between a user and the electronic device.

10. The method of claim 1, further comprising:
reducing, based on the first confidence score being above the first threshold, a luminosity of the touch-sensitive display.

11. An electronic device comprising:
a touch-sensitive display;
at least one processor; and
a non-transitory computer-readable storage medium storing one or more programs comprising instructions that when executed by the at least one processor cause the at least one processor to:
generate, based on a first touch input at a touch-sensitive display of an electronic device, a first touch frame, the first touch frame comprising a first heatmap matrix;
obtain contextual data associated with the electronic device;
determine if the contextual data satisfies contextual conditions;
in accordance with a determination that the contextual data satisfies contextual conditions, generate, based on a machine-learned model, a first confidence score for a first likelihood that one or more first hotspots within the first heatmap matrix are indicative of touch inputs from machine-learned entities, the machine-learned entities comprising at least one of portions of an ear or portions of a cheek;
generate, based on a second touch input at the touch-sensitive display of the electronic device, a second touch frame, the second touch frame comprising a second heatmap matrix;
generate, based on the machine-learned model, a second confidence score for a second likelihood that one or more second hotspots within the second heatmap matrix are indicative of touch inputs from machine-learned entities, the machine-learned entities comprising at least one of a portion of an ear, a finger, a thumb, a palm, hair, or a cheek; and
suppress, based on the second confidence score being above a first threshold and based on the first confidence score, touch inputs sufficient to provide an altered second touch frame, the altered second touch frame not including the one or more second hotspots.

12. (canceled)

13. The electronic device of claim 11, wherein the contextual data associated with the electronic device comprises information indicative of an operating state of the electronic device.

14. The electronic device of claim 13, wherein:
the electronic device further comprises a microphone, a speaker, and a communication system;
the operating state is indicative of an active voice call; and
the satisfaction of the contextual condition comprises a determination that the electronic device is facilitating the active voice call.

15. The electronic device of claim 13, wherein:
the electronic device further comprises a speaker;
the operating state is indicative of an active audio/video playback; and
the satisfaction of the contextual condition comprises a determination that the electronic device is facilitating the active audio/video playback.

16. The electronic device of claim 11, wherein:
the electronic device further comprises a radar sensor; and
the contextual data associated with the electronic device further comprises information indicative of at least one of an environment in which the electronic device resides.

17. The electronic device of claim 11, wherein the contextual data associated with the electronic device comprises information indicative of an ambient brightness surrounding the electronic device and an acceleration of the electronic device, and wherein the satisfaction of the contextual condition comprises a determination that the electronic device has been moved and received bright incident light.

18. The electronic device of claim 11, wherein the electronic device further comprises a proximity sensor, and wherein the non-transitory computer-readable storage medium further comprises instructions that when executed by the at least one processor further cause the at least one processor to:
obtain, based on the suppression of touch inputs, proximity sensor data; and
deactivate, based on the proximity sensor data and the second confidence score being above the first threshold, the touch-sensitive display.

19. The electronic device of claim 11, wherein the electronic device further comprises a proximity sensor, and wherein the non-transitory computer-readable storage medium further comprises instructions that when executed by the at least one processor further cause the at least one processor to:
obtain, prior to generating the second touch frame, proximity sensor data; and
determine, based on the first confidence score being above the first threshold, that the proximity sensor data is unrepresentative of a true proximity between a user and the electronic device.

20. The electronic device of claim 11, wherein the non-transitory computer-readable storage medium further comprises instructions that when executed by the at least one processor further cause the at least one processor to:
reduce, based on the first confidence score being above the first threshold, a luminosity of the touch-sensitive display.

21. The electronic device of claim 11, wherein the first touch input and the second touch input are contiguously received and both satisfy the contextual conditions.

22. The electronic device of claim 21, wherein the suppression of the touch inputs is further based on the first confidence score being above a second threshold and below the first threshold, the second threshold being lower than the first threshold.

23. The electronic device of claim 21, wherein the suppression of the touch inputs is further based on the first confidence score being above the first threshold.

24. The method of claim 1, wherein the first touch input and the second touch input are contiguously received and both satisfy the contextual conditions.

25. The method of claim 1, wherein suppressing the touch inputs is further based on the first confidence score being above a second threshold and below the first threshold, the second threshold being lower than the first threshold.

26. The method of claim 1, wherein suppressing the touch inputs is further based on the first confidence score being above the first threshold.
